(19) United States
(12) Patent Application Publication
(10) Pub. No.: US 2016/0299854 A1
(43) Pub. Date: Oct. 13, 2016

(54) TECHNIQUES FOR PREVENTING PHYSICAL ATTACKS ON CONTENTS OF MEMORY

(71) Applicant: QUALCOMM Incorporated, San Diego, CA (US)

(72) Inventors: Vinoth Kumar DEIVASIGAMANI, San Diego, CA (US); Laurence Geoffrey LUNDBLADE, San Diego, CA (US); Satish ANAND, San Diego, CA (US); Billy B. BRUMLEY, San Diego, CA (US)

(21) Appl. No.: 15/043,294

(22) Filed: Feb. 12, 2016

Related U.S. Application Data
(60) Provisional application No. 62/146,926, filed on Apr. 13, 2015.

(51) Int. Cl. G06F 12/14; G06F 21/64; G06F 21/78

(52) U.S. Cl. CPC G06F 12/1408; G06F 21/78; G06F 21/64; G06F 2212/402

(57) ABSTRACT

Techniques for providing countermeasures against physical attacks on the contents of off-chip memory are provided in which a pseudo-internal memory resistant to physical attack is used. The pseudo-internal memory is mapped to an address space such that the pseudo-internal memory appears to be on-chip memory to a processor or a system on a chip (SoC). A method for protecting sensitive data according to these techniques includes presenting, by a pseudo-internal memory module of a SoC, an address space as internal memory of the SoC, where the address space comprises memory located off-chip from the system on a chip, receiving a data write request at the pseudo-internal memory module from a component of the SoC, encrypting data associated with the data write request using the pseudo-internal memory module to generate encrypted data, and writing the encrypted data to the memory located off-chip from the SoC.

### CROSS REFERENCE TO RELATED APPLICATION

This application claims priority to U.S. Provisional Patent Application Ser. No. 62/146,926, entitled “TECHNIQUES FOR PREVENTING PHYSICAL ATTACKS ON CONTENTS OF MEMORY,” filed on Apr. 13, 2015, all of which are assigned to the assignee hereof and incorporated by reference.

### BACKGROUND

Double data rate synchronous dynamic random-access memory (DDR SDRAM) are a class of memory integrated circuits utilized in a wide variety of computing devices, such as mobile phones, tablet computer systems, gaming consoles, and/or other such computing devices. DDR memory can be susceptible to physical attacks in which an attacker attempts to extract sensitive information from the DDR memory and/or to modify contents of the memory in an attempt to assume control over the computing device. For example, an attacker may be able to force a processor of the computing device to execute program code that the processor otherwise would not execute. Some examples of physical attacks that an attacker may utilize include printed circuit board (PCB probing), tweezer attacks, and interposer attacks. An attacker may probe the traces of the DDR chip to read confidential information in the memory. An attacker may also insert an interposer between a System on a Chip (SoC) and the DDR to force the SoC to execute unauthorized code. A well-publicized example of such an attack occurred on the NINTENDO WII gaming console, in which attackers bridged pins in the memory module of the WII gaming console to access a key stored in a restricted portion of memory that can be used to decrypt NINTENDO game content. The attack also allowed hackers to discover additional information about the cryptographic system of the game console.

A conventional solution to such attacks is to execute sensitive code from an internal memory of the SoC, but such internal memory can be expensive. For example, a 64-bit TRUSTZONE kernel and applications may require several megabytes of memory. Typical internal memory may only comprise several kilobytes. The amount of internal memory required to run the kernel and the associated applications can be expensive. The TZ kernel and applications would have to utilize the DDR, which would leave the kernel and application susceptible to attack. Other types of software assets may also be associated with sensitive data but may require too much memory to run in the internal memory.

### SUMMARY

A method for protecting sensitive data according the disclosure includes presenting, by a pseudo-internal memory module of a system on a chip, an address space as internal memory of the system on a chip, wherein the address space comprises memory located off-chip from the system on a chip, receiving a data write request at the pseudo-internal memory module from a component of the system on a chip, encrypting data associated with the data write request using the pseudo-internal memory module to generate encrypted data, and writing the encrypted data to the memory located off-chip from the system on a chip.

Implementations of such a method may include on or more of the following features. Generating authentication information for authenticating the encrypted data, and writing at least a portion of the authentication information for authenticating the encrypted data to the memory located off-chip from the system on a chip. Generating the authentication information for authenticating the encrypted data includes generating an authentication tag associated with the data, and writing the at least a portion of the authentication information for authenticating the encrypted data to the memory located off-chip from the system on a chip comprises writing the authentication tag to the memory located off-chip from the system on a chip. Receiving a data read request at the pseudo-internal memory module from the component of the system on a chip; accessing the encrypted data associated with the data read request from the memory located off-chip from the system on a chip; decrypting the encrypted data using the pseudo-internal memory module to generate unencrypted data; authenticating the encrypted data using the pseudo-internal memory module; and providing the unencrypted data to the component responsive to the authentication indicating that the encrypted data was not modified since being written to the memory located off-chip from the system on a chip. Accessing the encrypted data associated with the data read request from the memory located off-chip from the system on a chip further includes accessing the authentication tag associated with the data; and authenticating the encrypted data using the pseudo-internal memory module includes authenticating the encrypted data using the authentication tag. Performing exception handling responsive to the authentication indicating that the encrypted data was modified since being written to the memory located off-chip from the system on a chip.

An apparatus according to the disclosure includes means for presenting, by a pseudo-internal memory module of a system on a chip, an address space as internal memory of the system on a chip, wherein the address space comprises memory located off-chip from the system on a chip; means for receiving a data write request at the pseudo-internal memory module from a component of the system on a chip; means for encrypting data associated with the data write request using the pseudo-internal memory module to generate encrypted data; and means for writing the encrypted data and authentication information to the memory located off-chip from the system on a chip.

Implementations of such an apparatus can include one or more of the following features. Means for generating authentication information for authenticating the encrypted data, and means for writing at least a portion of the authentication information for authenticating the encrypted data to the memory located off-chip from the system on a chip. The means for generating the authentication information for authenticating the encrypted data includes means for generating an authentication tag associated with the data, and the means for writing the at least a portion of the authentication information for authenticating the encrypted data to the memory located off-chip from the system on a chip includes means for writing the authentication tag to the memory located off-chip from the system on a chip. Means for receiving a data read request at the pseudo-internal memory module from the component of the system on a chip, means for accessing the encrypted data associated with the data read request from the memory located off-chip from the system on a chip, means for decrypting the encrypted data using the pseudo-internal memory module to generate unencrypted data, means for authenticating the encrypted data using the pseudo-internal memory module; and means for providing the unencrypted data to the component responsive to the authentication indicating that the encrypted data was not modified since being written to the memory located off-chip from the system on a chip. The means for accessing the encrypted data associated with the data read request from the memory located off-chip from the system on a chip further includes means for accessing the authentication tag associated with the data, and the means for authenticating the encrypted data using the pseudo-internal memory module include means for authenticating the encrypted data using the authentication tag. Means for performing exception handling responsive to the authentication indicating that the encrypted data was modified since being written to the memory located off-chip from the system on a chip.

A system on a chip according to the disclosure includes a pseudo-internal memory module, one or more components configured to read, write, or read and write data from memory associated with the pseudo-internal memory module; and a system interconnect configured to connect the one or more components and the pseudo-internal memory module. The pseudo-internal memory module is configured to present an address space as internal memory of the system on a chip, wherein the address space comprises a portion of memory located off-chip from the system on a chip, receive a data write request from a component of the one or more components, encrypt data associated with the data write request to generate encrypted data, and write the encrypted data to the memory located off-chip from the system on a chip.

Implementations of such a system on a chip can include one or more of the following features. The pseudo-internal memory module is further configured to generate authentication information for authenticating the encrypted data, and write at least a portion of the authentication information for authenticating the encrypted data to the memory located off-chip from the system on a chip. The pseudo-internal memory module is configured to generate an authentication tag associated with the data, and the pseudo-internal memory module is configured to write the authentication tag to the memory located off-chip from the system on a chip. The pseudo-internal memory module is configured to receive a data read request from the component of the one or more components, access the encrypted data associated with the data read request from the memory located off-chip from the system on a chip, decrypt the encrypted data to generate unencrypted data, authenticate the encrypted data, and provide the unencrypted data to the component responsive to the authentication indicating that the encrypted data was not modified since being written to the memory located off-chip from the system on a chip. The pseudo-internal memory module is configured to access the authentication tag associated with the data, and the pseudo-internal memory module is configured to authenticating the encrypted data using the authentication tag. The pseudo-internal memory module is configured to perform exception handling responsive to the authentication indicating that the encrypted data was not modified since being written to the memory located off-chip from the system on a chip.

A computing device according to the disclosure includes a system on a chip and an memory located off-chip from the system on a chip. the system on a chip is in communication with the memory located off-chip from the system on a chip, and the system on a chip also includes a pseudo-internal memory module. The pseudo-internal memory module is configured to present an address space as internal memory of the system on a chip, the address space comprising memory of the memory located off-chip from the system on a chip, receive a data write request from a component of the system on a chip, encrypt data associated with the data write request to generate encrypted data, and write the encrypted data to the memory located off-chip from the system on a chip.

Implementations of such a computing device can include one or more of the following features. The pseudo-internal memory module is further configured to generate authentication information for authenticating the encrypted data, and write at least a portion of the authentication information for authenticating the encrypted data to the memory located off-chip from the system on a chip. The pseudo-internal memory module is configured to generate an authentication tag associated with the data; and wherein the pseudo-internal memory module is configured to write the authentication tag to the memory located off-chip from the system on a chip. The pseudo-internal memory module is configured to receive a data read request from the component of the system on a chip, access the encrypted data associated with the data read request from the memory located off-chip from the system on a chip, decrypt the encrypted data to generate unencrypted data, authenticate the encrypted data, and provide the unencrypted data to the component responsive to the authentication indicating that the encrypted data was not modified since being written to the memory located off-chip from the system on a chip. The pseudo-internal memory module is configured to access the authentication tag associated with the data, and the pseudo-internal memory module is configured to authenticating the encrypted data using the authentication tag. The pseudo-internal memory module is configured to perform exception handling responsive to the authentication indicating that the encrypted data was not modified since being written to the memory located off-chip from the system on a chip.

### BRIEF DESCRIPTION OF THE DRAWINGS

FIG. 1 is a block diagram of an example computing device, which may be suitable for an implementing the techniques discussed herein.

FIG. 2 is a flow diagram of an example cryptographic write operation according to the techniques disclosed herein.

FIG. 3 is a flow diagram of an example cryptographic read operation according to the techniques disclosed herein.

FIG. 4 is a flow diagram of an example process for a write operation on a system on a chip using a pseudo-internal memory module according to the techniques disclosed herein.

FIG. 5 is a flow diagram of an example process for a read operation on a system on a chip using a pseudo-internal memory module according to the techniques disclosed herein.

FIG. 6 is a flow diagram of an example process for generating an authentication tag according to the techniques disclosed herein.

FIG. 7 is a flow diagram of an example process for generating a secondary authentication key according to the techniques disclosed herein.

FIG. 8 is a flow diagram of an example process for encrypting data according to the techniques disclosed herein.

FIG. 9 is a flow diagram of an example process for authenticating encrypted data according to the techniques disclosed herein.

FIG. 10 is a flow diagram of an example process for a generating a recovered tag from encrypted data according to the techniques disclosed herein.

### DETAILED DESCRIPTION

Techniques are disclosed herein that provide countermeasures against physical attacks on the contents of the off-chip memory, such as DDR memory or other memory that is external to a processor or a system on a chip. The techniques utilize a pseudo-internal memory (also referred to herein as a “pseudo-IMEM” or “pIMEM”) that is resistant to physical attack. The pseudo-internal memory is implemented in part in off-chip memory. However, the pseudo-internal memory may be mapped to an address space by a pseudo-internal memory module resident in the processor or system on a chip such that the pseudo-internal memory (and possibly other off-chip memory as discussed below) appears to be internal memory of the processor or system on a chip to components of the processor or system on a chip. Data that is written to the pseudo-internal memory may be remastered by the pseudo-internal memory module and stored in the off-chip memory. The pseudo-internal memory module implements cryptographic algorithms that enable the pseudo-internal memory module to offer confidentiality, integrity and freshness guarantees for the data stored in the pseudo-internal memory.

The pseudo-internal memory module can protect the confidentiality of the data through the use of any suitable encryption algorithm such as, for example, an Advanced Encryption Standard (AES) algorithm. The use of the term “encryption algorithms” herein can refer to different types of encryption algorithms and/or different modes of encryption algorithms. For example, the pseudo-internal memory module can be configured to use one or more modes of the encryption algorithm, such as but not limited to an Electronic Codebook (ECB) mode, Ciper Block Chaining book (CBC) mode, or Counter (CTR) mode.

In one embodiment, the pseudo-internal memory module can ensure the integrity of the data through the use of a SipHash algorithm or other hashing algorithm. For example, the pseudo-internal memory module can store a reference tag of each portion of encrypted data in memory located off-chip from the system on a chip (also referred to herein as “external memory”) generated using a hash key that is substantially inaccessible from outside the system on a chip. If an attacker were to modify the encrypted data or hash of the encrypted data stored in the pseudo-internal memory, the hash value of the modified encrypted data would no longer match the reference tag, which can indicate that the encrypted data has been modified.

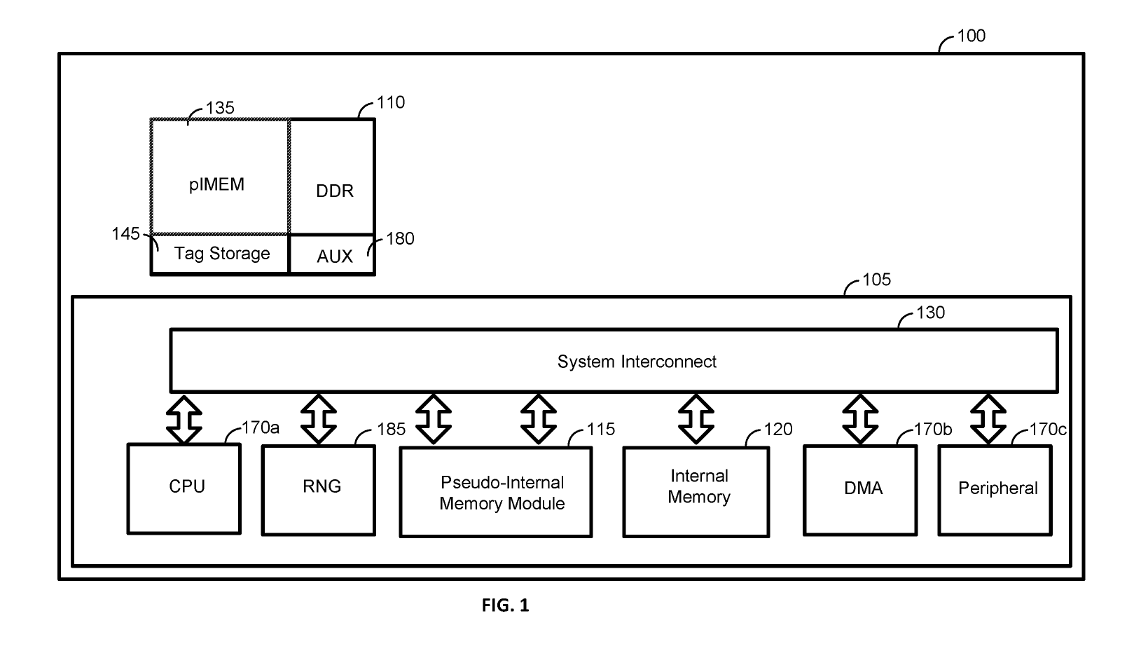

FIG. 1 is a logical block diagram of a computing device 100 that can be used to implement the techniques disclosed herein. The system on a chip (SoC) 105 comprises a system interconnect 130 or communication fabric that serves to interconnect the components of the SoC 105. The SoC 105 also includes a plurality of master devices 170 (denoted by 170a, 170b, etc.), a pseudo-internal memory module 115, and an internal memory (IMEM) 120. The master devices can include one or more components of the SoC 105, such as at least one processor 170a, one or more DMA controllers 170b, and/or one or more peripherals 170c. The SoC 105 can include other master devices in addition to or instead of one or more of the master devices depicted in the example illustrated in FIG. 1. For example, the SoC 105 can include a USB controller, a Universal Flash Storage (UFS) QDSP, and/or other devices. The master devices have also been referred to herein as “components” of the SoC 105.

The computing device 100 also includes an off-chip memory 110 that is external to the SoC 105. The off-chip memory 110 can comprise DDR SDRAM and/or other non-transitory computer readable media.

In one embodiment, the off-chip memory 110 may include one or more portions that can be used by the pseudo-internal memory module to store information (e.g., data, tags, etc.) such as, for example, the pseudo-internal memory 135, the tag storage 145, and the encryption-related auxiliary data storage 180. The pseudo-internal memory 135, the tag storage 145, and the encryption-related auxiliary data storage 180 (for implementations where auxiliary data is stored) can be implemented as either separate areas of the off-chip memory 110 or can comprise interleaved portions of memory. For example, corresponding portions of the pseudo-internal memory 135, the tag storage 145, and the encryption-related auxiliary data storage 180 associated with each frame of data can be stored in adjacent memory locations to improve efficiency for accessing the data from the off-chip memory 110. The pseudo-internal memory module 115 can be configured such that the pseudo-internal memory 135, the tag storage 145, and/or the encryption-related auxiliary data storage 180 are included in an address space that the pseudo-internal memory module 115 presents as internal memory of the SoC 105.

In one embodiment, the off-chip memory 110 may include pseudo-internal memory 135, which can be used by the pseudo-internal memory module 115 to store encrypted data. In some cases, the data stored in the pseudo-internal memory 135 can be cryptographically processed by the pseudo-internal memory module 115 to ensure confidentiality, integrity and freshness.

In one embodiment, the pseudo-internal memory module 115 can be configured to control a level of protection offered for each frame of data. For example, the pseudo-internal memory module can be configured to provide a confidentiality-only protection level, an integrity only protection level, a confidentiality and integrity protection level, and confidentiality, integrity, and/or replay protection level. If the protection level requires confidentiality protection, the data stored in the pseudo-internal memory 135 can be encrypted or otherwise obfuscated by the pseudo-internal memory module 115 before being written to the pseudo-internal memory 135. If the protection level requires protection from replay attacks, the pseudo-internal memory module 115 can be configured to provide a SoC-stored component of the key or other information used to encrypt or obfuscate the data in the pseudo-internal memory 135. If the protection level requires integrity protection, the pseudo-internal memory module 115 can generate a message authentication code (MAC) or other authentication information for determining whether the contents of the pseudo-internal memory module 115 have been altered. Persons skilled in the art will appreciate that the pseudo-internal memory module 115 may provide other levels of protection in addition to and/or instead of the one or more levels of protection provided in these examples.

The level of protection can be configured by setting a level of protection value in a one-time programmable memory of the SoC 105. The pseudo-internal memory module 115 can be configured to read the level of protection value and to operate using the appropriate level of protection. The level of protection value can be set at the time that the SoC 105 and/or the computing device 100 is manufactured or provisioned and can be used to provide varying levels of confidentiality, integrity, and/or replay protection level to the data to be stored in the pseudo-internal memory 135. In some implementations, no protection may be desired and the level of protection can be set to a no-protection value. However, the pseudo-internal memory module 115 can be configured to still present the mapping to the components of the SoC 105 such that the pseudo-internal memory 135, the tag storage, and/or the auxiliary data storage 180 appear to be an internal memory of the SoC 105. The no-protection level may be desirable where the software and/or hardware of the computing device 100 is operated in a controlled environment where the risk of malicious attacks on the data stored in the pseudo-internal memory 135 is low.

Depending on the type of encryption algorithm and/or the mode of the encryption algorithm implemented by the pseudo-internal memory module 115, an encryption-related auxiliary data storage 180 can also be reserved as a part of the off-chip memory 110. For example, where the pseudo-internal memory module 115 is configured to utilize the CTR mode of a block cipher encryption algorithm that requires a nonce, the nonce can be stored in the encryption-related auxiliary data storage 180.

Other types of encryption-related auxiliary data can be stored in the encryption-related auxiliary data storage 180 by the pseudo-internal memory module 115. The specific types of auxiliary data that may be stored in the encryption-related auxiliary data storage 180 are dependent upon the types of encryption algorithm and/or the mode of operation of the algorithm being utilized by the pseudo-internal memory module 115. The pseudo-internal memory module 115 can be configured to store such auxiliary data in the encryption-related auxiliary data storage 180 and to access such auxiliary data as needed for the encryption and/or decryption processes described herein. In one embodiment, the contents of the encryption-related auxiliary data storage 180 can be encrypted by the pseudo-internal memory module 115 to make it more difficult for an attacker to make use of the data stored therein to attempt to decrypt the contents of the pseudo-internal memory 135.

In addition, the off-chip memory 110 may include tag storage 145, which can be used by the pseudo-internal memory module 115 to store message authentication codes associated with the encrypted data stored in the pseudo-internal memory 135. As used herein, a “message authentication code” or “MAC” can be used to determine whether a particular frame of encrypted data has been altered since the frame of encrypted data was written to the pseudo-internal memory 135. Thus, a message authentication code can be generated for each frame of encrypted data stored in the pseudo-internal memory 135, and the pseudo-internal memory module 115 can be configured to associate each hash tag with the frame number of the corresponding frame of encrypted data stored in the pseudo-internal memory 135.

In one embodiment, the contents of the tag storage 145 can be encrypted by the pseudo-internal memory module 115 and thus stored in the off-chip memory 110 in encrypted form. This can provide an additional level of protection for the stored message authentication codes.

In some implementations, in addition to encrypting the contents of the tag storage 145, the pseudo-internal memory module 115 can be configured to authenticate the contents of the tag storage 145. For example, the pseudo-internal memory module 115 can be configured to recursively authenticate the contents of the tag storage 145 by building a tree structure of hashes that can be used to ensure data freshness with minimal on-chip storage requirements. The pseudo-internal memory module 115 can be configured to minimize the on-chip storage requirements by storing only the root of the hash tree in the on-chip storage.

In another embodiment, the contents of the tag storage 145 can be stored by the pseudo-internal memory module 115 in an unencrypted form. For example, the tag storage 145 may not contain sensitive data, and thus may not need to be encrypted. Thus, in some embodiments, at least some portions of the data in the off-chip memory 110 outside of the pseudo-internal memory 135 is unencrypted and may be susceptible to physical attack.

The pseudo-internal memory module 115 can be configured as both a slave and a master on the system interconnect 130. For example, the slave address space can map to at least a portion of the internal memory 120 and the pseudo-internal memory 135. The slave address space can also map to other internal memory of the SoC 105. The pseudo-internal memory module 115 can configure the slave address space such that the space appears as an internal memory similar to that of the internal memory 120 to components of the SoC 105.

The master devices 170 are configured as master devices on the system interconnect 130, which can allow the master devices to write data to the pseudo-internal memory module 115 or to read data from the pseudo-internal memory module 115. The master devices 170 on the system interconnect 130 do not require any special changes to make use of the pseudo-internal memory module 115. The master devices 170 can transact with the pseudo-internal memory module 115 via the system interconnect 130 as if the pseudo-internal memory module 115 were an internal memory similar to the internal memory 120 supporting standard interconnect protocol such as the Advanced eXtensible Interface (AXI) protocol, the Advanced Microcontroller Bus Architecture (AMBA) High-Performance Bus (AHB) protocol, or another such standard interconnect protocol suitable for connection and management of functional blocks on an SoC. Furthermore, because the pseudo-internal memory 135 is memory mapped, the pseudo-internal memory 135 looks like a large internal memory to software being executed by the at least one processor 170a. As a result, no software changes are required to utilize the pseudo-internal memory 135.

Moreover, the pseudo-internal memory module 115 and the pseudo-internal memory 135 can be configured to not depend on the cache hardware of the SoC 105. Consequently, non-cacheable accesses and unaligned transactions can be handled gracefully without requiring changes to the cache hardware.

The pseudo-internal memory module 115 and the pseudo-internal memory 135 can enable secure elements to be run in the pseudo-internal memory 135 without the risks normally associated with the off-chip memory 110. For example, secure software assets can be loaded into the pseudo-internal memory 135 that would otherwise be too large for the internal memory 120. The pseudo-internal memory 135 can provide sufficient space for these secure elements without the risks associated with running these secure elements in the off-chip memory 110. The protections provided by the pseudo-internal memory module 115 and the pseudo-internal memory 135 significantly reduce the risk that an attacker could obtain and/or modify the information associated with these software assets.

In one embodiment, the pseudo-internal memory module 115 can be configured to receive read request and/or write requests that are less than a frame in size. With respect to read requests, the pseudo-internal memory module 115 can be configured to perform a read operation for the entire frame of data that includes the requested data. In the event that the requested data is less than the entire frame, the pseudo-internal memory module 115 may discard the excess data. With respect to write requests, the pseudo-internal memory module 115 can be configured to perform a write operation for the entire frame of data. This may include performing a read? operation on the frame of data, modifying the frame of data that was read with the data that was provided in the write request, and writing the full frame of data.

The computing device 100 can optionally include a random number generator (RNG) 185. The pseudo-internal memory module 115 can be configured to use the RNG 185 to provision the various keys associated with the processes discussed herein. For example, the pseudo-internal memory module 115 can be configured to send a request to the RNG 185 for a key value, and in response, receive a random number key value from the RNG 185. The RNG 185 can be used to add an additional level of security to the processes discussed herein. In one embodiment, the keys generated by the RNG 185 can be provisioned by the RNG 185 without any software intervention, which can help the RNG 185 protect against potential compromise from an attacker.

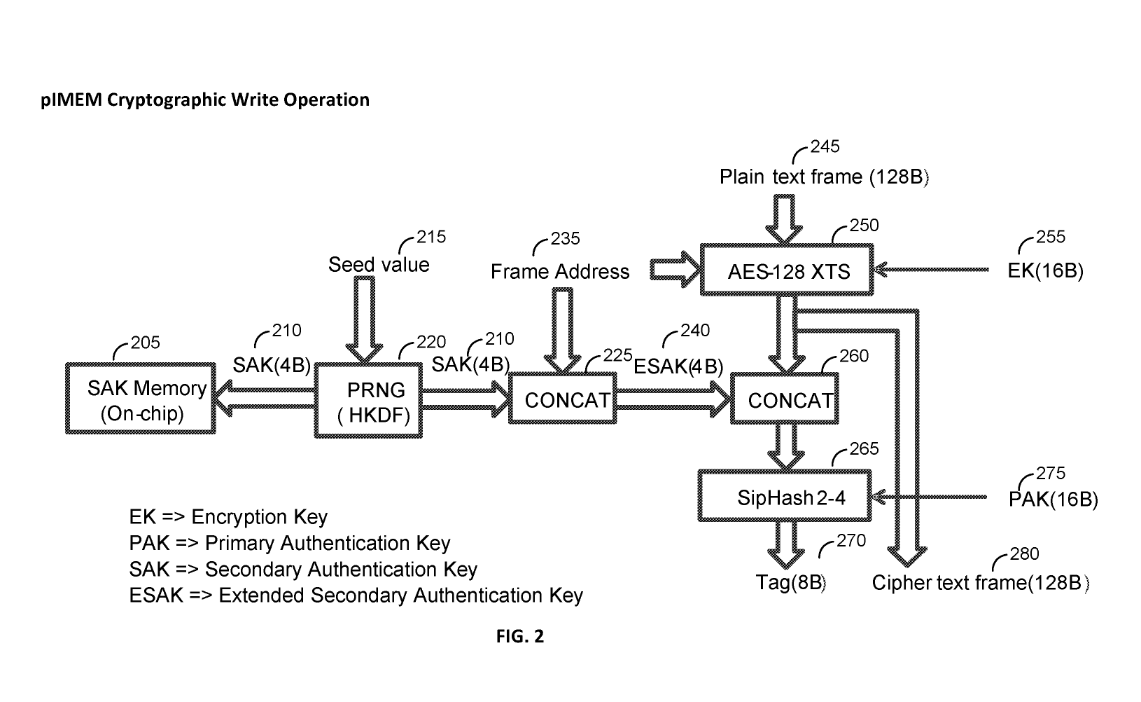

FIGS. 2-10, which are discussed in detail below, illustrate some examples of the types of processing that the pseudo-internal memory module 115 can perform on the data in the pseudo-internal memory 135, the tag storage 145, and/or the encryption-related auxiliary data storage 180. For example, the pseudo-internal memory module 115 can write encrypted data to the pseudo-internal memory 135.

FIG. 2 is a flow diagram of an example process for a cryptographic write operation using the computing device illustrated in FIG. 1. The process illustrated in FIG. 2 can be implemented by the pseudo-internal memory module 115, unless otherwise specified. FIG. 2 illustrates various functional blocks or modules of the pseudo-internal memory module 115 that can implement various stages of the cryptographic write operation. The blocks and/or modules illustrated in FIG. 2 can be implemented in hardware, firmware, software, or a combination thereof. Persons skilled in the art will appreciate that FIG. 2 merely illustrates one particular approach for a cryptographic write operation such that the pseudo-internal memory module may be configured to add, omit, or replace one or more functional blocks or modules in performing a cryptographic write operation.

As illustrated in FIG. 2, the pseudo-internal memory module 115 receives a plain text frame 245 of data to be written to the pseudo-internal memory 135. The plain text frame 245 can be received from the at least one processor 170a or another of the master devices 170 as discussed above with respect to FIG. 1. The plain text frame 245 is provided as input to the encryption block 250. In the example illustrated in FIG. 2, the encryption block 250 is configured to apply the AES-128 XTS encryption algorithm. AES-XTS is designed for use in encrypting data for storage on a hard disk or other forms of block oriented computer memory. While the encryption block 250 in the example illustrated in FIG. 2 uses XTS-AES to encrypt the plain text frame 245, persons skilled in the art will appreciate that the encryption block 250 can be configured to use other encryption techniques instead of AES-XTS.

In addition to the plain text frame 245, the encryption block 250 receives an encryption key (EK) 255 and frame address 235 as inputs. The EK 255 can be stored in an on-chip memory or built into the SoC 105 such that the EK 255 is substantially inaccessible outside of the SoC 105. For example, the EK 255 can be stored in an internal memory of the SoC 105 (e.g., internal memory 120 of FIG. 1) that is substantially inaccessible from outside of the SoC 105 to protect the encryption key (EK 255) from being obtained by an attacker. The EK 255 may be valid only for the power cycle, and the SoC 105 can be configured to regenerate the EK 255 each time the SoC 105 is rebooted.

The frame address 235 may represent the address of the frame in the slave address space provided by the pseudo-internal memory module 115. As discussed above, the memory mapping provided by the pseudo-internal memory module 115 makes pseudo-internal memory 135 appear as internal memory of the SoC 105 to the components of the SoC 105 (e.g., the master devices 170). In other words, the pseudo-internal memory 135 may function in a similar manner as the internal memory 120 (FIG. 1). Because this memory is presented to the master devices 170 as internal memory, the master devices 170 of the SoC 105 can be configured to read and/or write data from the pseudo-internal memory 135 as if the pseudo-internal memory 135 were internal memory. Consequently, the master devices 170 can operate as master devices with the pseudo-internal memory 135 serving as a slave device, or vice versa.

As further illustrated in FIG. 2, the encryption block 250 outputs a cipher text frame 280. The cipher text frame 280 is stored in the off-chip memory 110 comprising the pseudo-internal memory 135. The cipher text frame 280 may be encrypted before leaving the SoC 105 to provide confidentiality. In one embodiment, the EK 255 is not frame specific and can be used by the pseudo-internal memory module 115 to generate the cipher text frame 280 for each frame of data to be stored in the off-chip memory 110 or pseudo-internal memory 135.

The pseudo-random number generator block (“PRNG block”) 220 receives a seed value 215 as input. The pseudo-random number generator block 220 can be used instead of or in addition to the RNG 185 of FIG. 1.

The seed value 215 can be any suitable value that is generated at any suitable time. For example, the seed value 215 can be a random value that is used as a seed for the PRNG block 220. The seed value 215 can be generated at power up of the computing device 100. As another example, the seed value 215 can be a selected value that is stored in an on-chip memory of the SoC 105 (e.g., internal memory 120 of FIG. 1) and/or can be built into the pseudo-internal memory module 115 of the SoC 105.

The PRNG 220 generates a secondary authentication key (“SAK”) 210, which will be used to authenticate the cipher text frame 280 when retrieving the cipher text frame 280 from the pseudo-internal memory 135. In one embodiment, the PRNG block 220 can implement a Hash-based Message Authentication Code (HMAC)-based Key Derivation Function (HKDF) to generate the secondary authentication key (SAK 210). The secondary authentication key (SAK 210) can be stored in a SAK memory 205, which is located on the SoC 105. The SAK memory 205 is located on the SoC 105 to ensure that the SAK is maintained in a location that is substantially inaccessible to an attacker. Storing the SAK in the SAK memory 205 provides a SoC-stored component of the key that can protect against replay attacks.

The SAK 210 is also provided to the concatenation block 225 that concatenates the SAK 210 with the frame address 235 to generate an extended secondary authentication key (ESAK) 240. The ESAK 240 is therefore associated with the frame number associated with the cipher text frame 280 that is being written to the pseudo-internal memory 135. The ESAK 240 can be stored in an on-chip memory (e.g., internal memory 120 of FIG. 1), such that the ESAK 240 is substantially inaccessible outside of the SoC 105.

The ESAK 240 is input to the concatenation block 260, which concatenates the cipher text frame 280 and the ESAK 240. The concatenated result from the concatenation block 260 is sent to hash block 265.

A primary authentication key (PAK) 275 is also input into the hash block 265. The PAK 275 is not frame specific and can be used by the pseudo-internal memory module 115 to generate the reference tag 270 (also referred to herein as an “authentication tag” or “message authentication code”) for each frame of data to be stored in the pseudo-internal memory 135. The PAK 275 can be stored in an on-chip memory (e.g., internal memory 120 of FIG. 1) or built into the SoC 105 such that the PAK 275 is substantially inaccessible outside of the SoC 105. The PAK 275 may be valid only for the power cycle, and the SoC 105 can be configured to regenerate the PAK 275 each time that the SoC 105 is rebooted.

The hash block 265 can be configured to use a SipHash algorithm to generate a reference tag 270 based on the concatenated value generated by concatenation block 260 and the PAK 275. In one embodiment, the hash block 265 can be configured to apply a SipHash function having any suitable number of rounds per message block or finalization rounds to generate the reference tag 270. For example, the hash block 265 can be configured to apply SipHash-2-4, where “2” is the number of rounds per message block and “4” is the number of finalization rounds. Persons skilled in the art will appreciate that the hash block 265 can also be configured to apply other types of authentication algorithms in addition to or instead of a SipHash function.

The reference tag 270 can be used to determine whether the cipher text frame 280 associated with the reference tag 270 has been altered since the cipher text frame 280 was written to the pseudo-internal memory 135. The reference tag 270 can be stored by the pseudo-internal memory module 115 in the tag storage 145 (FIG. 1). Alternatively, in some implementations, the reference tag 270 can be stored by the pseudo-internal memory module 115 in an on-chip memory of the SoC 105 (e.g., internal memory 120 of FIG. 1). However, due to the limited size of the internal memory 120 and/or other on-chip memory of the SoC 105, the amount of protected memory available for the reference tags may be limited.

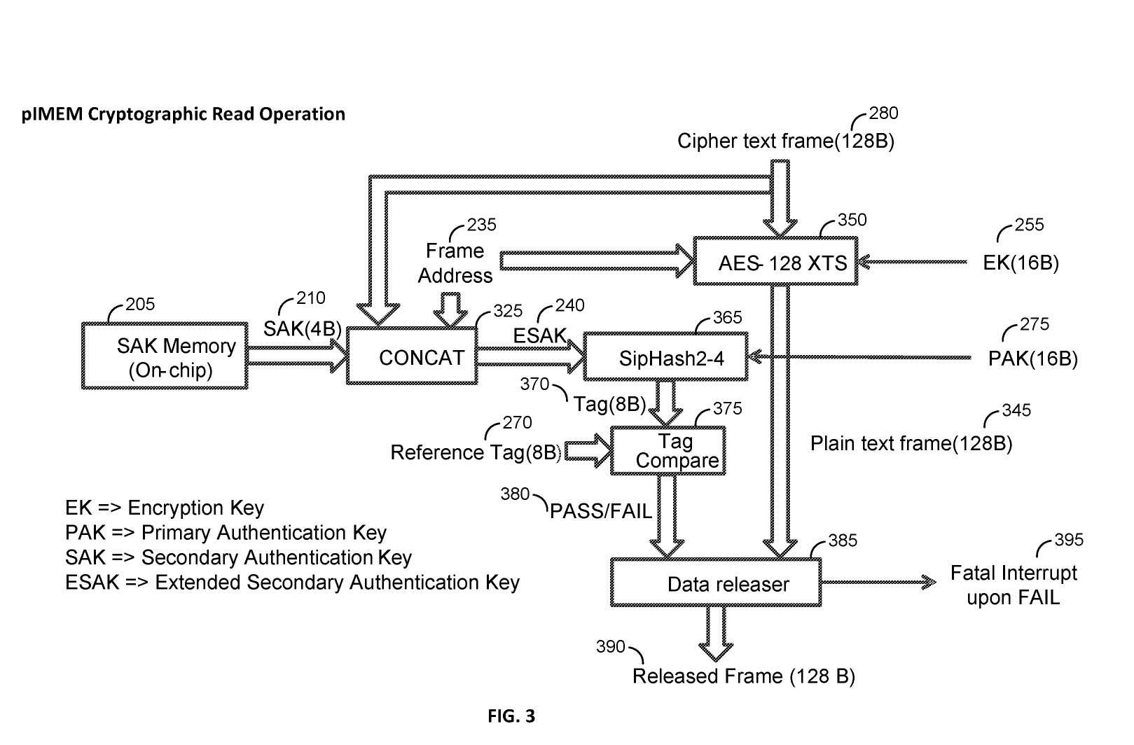

In some implementations, the pseudo-internal memory module 115 can associate the reference tag 270 with the frame address of the cipher text frame 280 so that the reference tag 270 associated with the frame can be accessed during a read operation, such as that illustrated in FIG. 3. The authentication keys, ESAK 240 and PAK 275, are substantially inaccessible from outside of the SoC 105 to prevent an attacker from altering the reference tag 270 stored in the tag storage 145 and the cipher text frame 280 stored in the pseudo-internal memory 135 in an attempt to assume control of the SoC 105.

The pseudo-internal memory module 115 can read encrypted data from the pseudo-internal memory 135. FIG. 3 is a flow diagram of an example process for a cryptographic read operation using the computing device illustrated in FIG. 1. The process illustrated in FIG. 3 can be implemented by the pseudo-internal memory module 115, unless otherwise specified. FIG. 3 illustrates various functional blocks or modules of the pseudo-internal memory module 115 that can implement various stages of the cryptographic read operation. The blocks and/or modules illustrated in FIG. 3 can be implemented in hardware, firmware, software, or a combination thereof. The process illustrated in FIG. 3 can be used to read, decrypt, and authenticate encrypted data stored in the pseudo-internal memory 135 using the process illustrated in FIG. 2. Persons skilled in the art will appreciate that FIG. 3 merely illustrates one particular approach for a cryptographic read operation such that the pseudo-internal memory module may be configured to add, omit, or replace one or more functional blocks or modules in performing a cryptographic read operation.

The cipher text frame 280 that was encrypted and stored in the pseudo-internal memory 135 in the process illustrated in FIG. 2 can be accessed from the pseudo-internal memory 135 by the pseudo-internal memory module 115. The decryption block 350 receives the cipher text frame 280 and the encryption key (EK) 255 that was used by the encryption block 250 to encrypt the plain text frame 245. The decryption block 350 can be configured to implement the appropriate decryption algorithm for decrypting content encrypted using the encryption algorithm and/or mode of encryption algorithm implemented by the encryption block 250. For example, where the encryption block 250 implements an AES-XTS encryption algorithm as discussed above, the decryption block 350 implements the appropriate decryption algorithm.

The pseudo-internal memory module 115 can be implemented such that the encryption block 250 and the decryption block 350 are implemented as a single module or as separate modules. Furthermore, the encryption block 250 and the decryption block 350 can be configured to implement more than one encryption/decryption algorithm and/or mode of encryption/decryption algorithm.

The decryption block 350 is configured to decrypt the cipher text frame 280 and output the plain text frame 345. If the cipher text frame 280 was not altered while stored in the pseudo-internal memory 135, the contents of the plain text frame 345 should match the contents of the plain text frame 245 that was originally encrypted and stored in the pseudo-internal memory 135 by the pseudo-internal memory module 115.

The secondary authentication key (SAK) 210 is retrieved by the pseudo-internal memory module 115 from the SAK memory 205. For example, the pseudo-internal memory module 115 can be configured to use the frame address 235 of the frame to look up the SAK 210 associated with the cipher text frame from the SAK memory 205. The concatenation block 325 concatenates the SAK 210 with the frame address 235 of the cipher text frame to generate the extended secondary authentication key (ESAK) 240 which was originally used to generate the reference tag 270 associated with the cipher text frame 280. The concatenation block 325 also concatenates the recovered ESAK with the cipher text frame 280 in a similar fashion as the approach used by the concatenation block 260 in the write operation illustrated in FIG. 2.

The output from the concatenation block 325 is provided as input to the hash block 365. The hash block 365 implements the same hash function as the hash block 265 used in the write operation illustrated in FIG. 2. The pseudo-internal memory module 115 can be implemented such that the hash block 265 and the hash block 365 are implemented as a single module or as separate modules.

In one embodiment, the hash block 265 and the hash block 365 can be configured to implement more than one hashing algorithm. In this embodiment, the pseudo-internal memory module 115 can be configured to instruct the hash block 365 to use the same hashing algorithm to generate the reference tag 270 for the cipher text frame 280.

In one embodiment, information identifying which algorithm was used can be stored in an on-chip memory of the SoC 105 (e.g., internal memory 120 of FIG. 1) and accessed by the pseudo-internal memory module 115. For example, information identifying which hashing and/or encryption algorithm and/or mode of encryption algorithm was used to generate a particular cipher text frame can be associated with the frame number of the cipher text frame. The pseudo-internal memory module 115 can use the frame number to look up which decryption algorithm to instruct the decryption block 350 to use and/or which hashing algorithm to instruct the hash block 365 to use.

The hash block 365 outputs a recovered tag 370. The tag compare block 375 is configured to receive the recovered tag 370 as input and the reference tag 270 generated during the write operation illustrated in FIG. 2. The reference tag 270 can be stored in off-chip or on-chip memory. In one embodiment, the reference tag 270 can be stored in the tag storage 145 of the off-chip memory 110, and the pseudo-internal memory module 115 can be configured to access tag storage 145 of the off-chip memory 110 to obtain the reference tag 270. In another embodiment, the reference tag 270 can be stored in an on-chip memory (e.g., internal memory 120 of FIG. 1), and the pseudo-internal memory module 115 can be configured to access the on-chip memory to obtain the reference tag 270.

The reference tags corresponding to each frame of data stored in the pseudo-internal memory 135 by the pseudo-internal memory module 115 can be associated with their frame number. The pseudo-internal memory module 115 can use the frame number to obtain the reference tag 270 associated with the frame being read from the pseudo-internal memory 135.

The tag compare block 375 compares the reference tag 270 with the recovered tag 370. The tag compare block 375 generates pass-fail decision information 380. The pass-fail decision information 380 indicates whether the recovered tag 370 matches the reference tag 270. The recovered tag 370 should match the reference tag 270 if the cipher text frame 280 has not been altered since it was written to the pseudo-internal memory 135.

The data releaser block 385 is configured to receive the plain text frame 345 from the decryption block 350 and the pass-fail decision information 380 from the tag compare block 375. In one embodiment, in response to the pass-fail decision information 380 indicating that the recovered tag 370 matches the reference tag 270, the data releaser block 385 may release the plain text frame 345 as released frame 390 to the master device of the master devices 170 requesting the frame. Moreover, responsive to the pass-fail decision information 380 indicating that the recovered tag 370 did not match the reference tag 270, the data releaser block 385 of pseudo-internal memory module 115 is configured to raise a fatal interrupt 395. The data releaser block 385 raises the interrupt to prevent data that has been altered since it was written to the pseudo-internal memory 135 from being used. The data may have been altered by an attacker or may be otherwise corrupted and should not be used.

The raising of the fatal interrupt by data releaser block 385 can signal to the at least one processor 170a to take some action to halt the execution of the program code associated with the cryptographic read operation. For example, the at least one processor 170a can be configured to perform a reboot of the computing device 100.

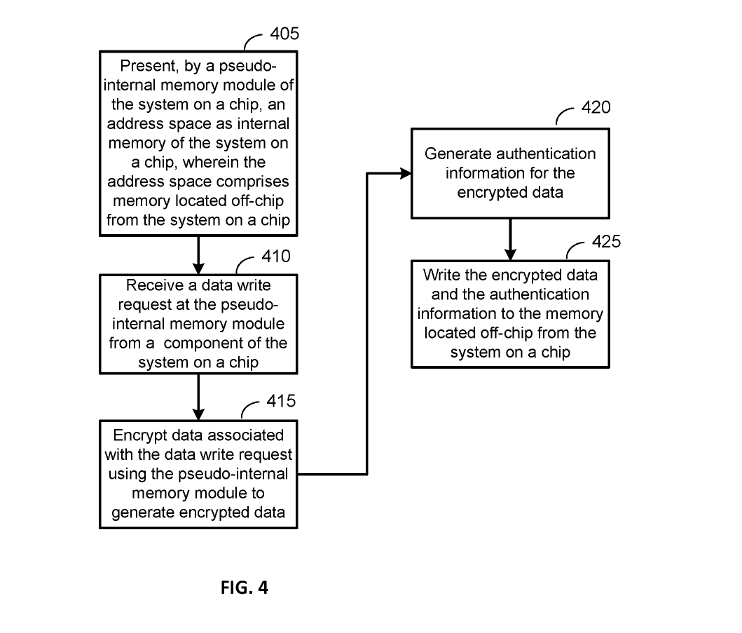

FIG. 4 is a flow diagram of an example process for a write operation on a system on a chip using a pseudo-internal memory module according to the techniques disclosed herein. The process illustrated in FIG. 4 can be implemented in a computing device, such as the computing device 100 illustrated in FIG. 1, and unless otherwise specified, the stages of the process of FIG. 4 can be implemented using a pseudo-internal memory module such as the pseudo-internal memory module 115 of FIG. 1.

The pseudo-internal memory module 115 of the SoC 105 can present an address space comprising pseudo-internal memory 135 located off-chip from the SoC 105 as internal memory (stage 405). In one embodiment, the pseudo-internal memory module 115 of the SoC 105 can be configured as a slave on the system interconnect 130 and can provide a specified range of address space to the master devices 170 of the SoC 105. The provided address space may appear to master devices 170 of the SoC 105 to be internal memory, similar in functionality to internal memory 120, but the address space may actually be mapped to the pseudo-internal memory 135. The pseudo-internal memory 135 may be a portion of the off-chip memory 110 that the pseudo-internal memory module 115 uses to store encrypted data. In one embodiment, the pseudo-internal memory module 115 can be configured such that the tag storage 145 and/or the encryption-related auxiliary data storage 180 can be included in an address space that the pseudo-internal memory module 115 presents as internal memory of the SoC 105.

The pseudo-internal memory module 115 can receive a data write request from a component of the system on a chip to store data in the memory represented as internal memory (stage 410). The component of the SoC 105 can be one of the master devices 170 illustrated in the example SoC 105 illustrated in FIG. 1 or can be a different component of the SoC 105.

The data write request can comprise a frame of unencrypted data, also referred to herein as the plain text frame 245 (FIG. 2), to be written to the pseudo-internal memory 135 that the pseudo-internal memory module 115 has represented to the other components of the SoC 105 as internal memory. The data write request can also include a frame identifier, which can correspond to the frame address 235 of the frame in the memory space mapped by the pseudo-internal memory module 115. The master devices 170 of the SoC 105 requesting the frame of data to be written to the pseudo-internal memory 135 need not be configured to perform any additional steps or processing than would ordinarily be required for the component to write to an internal memory of the SoC 105, such as the internal memory 120.

The component of the SoC 105 requesting the data write can be configured as a master on the system interconnect 130, and as discussed above, the pseudo-internal memory module 115 can be configured as a slave on the system interconnect 130 for the purposes of receiving data to be written to the pseudo-internal memory 135. While the example write request illustrated in FIG. 4 discusses writing a frame of data to the pseudo-internal memory 135, the techniques disclosed herein are not limited to a frame of data. Other implementations can be configured to handle other amounts of data. The amount of data that can be included in a write request may depend at least in part on the types of encryption algorithms and/or modes of encryption algorithms and/or hash algorithms implemented by the pseudo-internal memory module 115 and/or limitations of one or more components of the SoC 105 and/or the off-chip memory 110.

The pseudo-internal memory module 115 can encrypt data associated with the data write request to generate encrypted data (stage 415). The pseudo-internal memory module 115 can be configured to use the process illustrated in FIG. 2 to encrypt the data to be written to the pseudo-internal memory 135. As discussed above with respect to FIG. 2, the pseudo-internal memory module 115 can comprise an encryption block 250 that can be used to encrypt the data received, which is referred to in FIG. 2 as plain text frame 245. The encrypted data is referred to in FIG. 2 as cipher text frame 280. The pseudo-internal memory module 115 can be configured to use encryption keys, such as the encryption key (EK) 255 and/or the other encryption keys referred to in FIGS. 2 and 3, to encrypt the frame of data received with data write request. The EK 255 may be valid only for the power cycle, and the SoC 105 can be configured to regenerate the EK 255 each time that the SoC 105 is rebooted.

The pseudo-internal memory module 115 can generate authentication information for the encrypted data (stage 420). The pseudo-internal memory module 115 can also be configured to generate information that can be used to authenticate the encrypted data retrieved from the pseudo-internal memory 135 and to verify the freshness of the data. For example, the pseudo-internal memory module 115 can be configured to generate a hash of the frame of data to be written to the pseudo-internal memory 135. As illustrated in FIG. 2, for instance, the pseudo-internal memory module 115 can include a hash block 265 for generating a reference tag 270 that can later be used to determine whether the encrypted data was modified after the encrypted data was written to the pseudo-internal memory 135.

The encrypted data and the authentication information can be written to the pseudo-internal memory 135 located off-chip from the SoC 105 by the pseudo-internal memory module 115 (stage 425). In one embodiment, the pseudo-internal memory module 115 can be configured as a master on the system interconnect 130 such that the pseudo-internal memory module 115 can write data to the pseudo-internal memory 135 portion of the off-chip memory 110. In other words, the pseudo-internal memory module 115 can include both a master port and a slave port. The slave port of the pseudo-internal memory module 115 can be configured to accept transactions from the master devices 170, such as at least one processor 170a, one or more DMA controllers 170b, and/or one or more peripherals 170c. The master port of the pseudo-internal memory module 115 can be configured to write data to the off-chip memory 110, the pseudo-internal memory 135, the tag storage 145, and the encryption-related auxiliary data storage 180.

The pseudo-internal memory module 115 can be configured to store the authentication information in tag storage 145 of the off-chip memory 110. For example, the pseudo-internal memory module 115 can be configured to store the reference tag 270 in the tag storage 145 of the off-chip memory 110. Alternatively, in another embodiment, the reference tag 270 and/or other authentication information can be stored in an internal memory of the SoC 105 (e.g., internal memory 120 of FIG. 1) rather than writing the authentication information to the tag storage 145 of the off-chip memory 110.

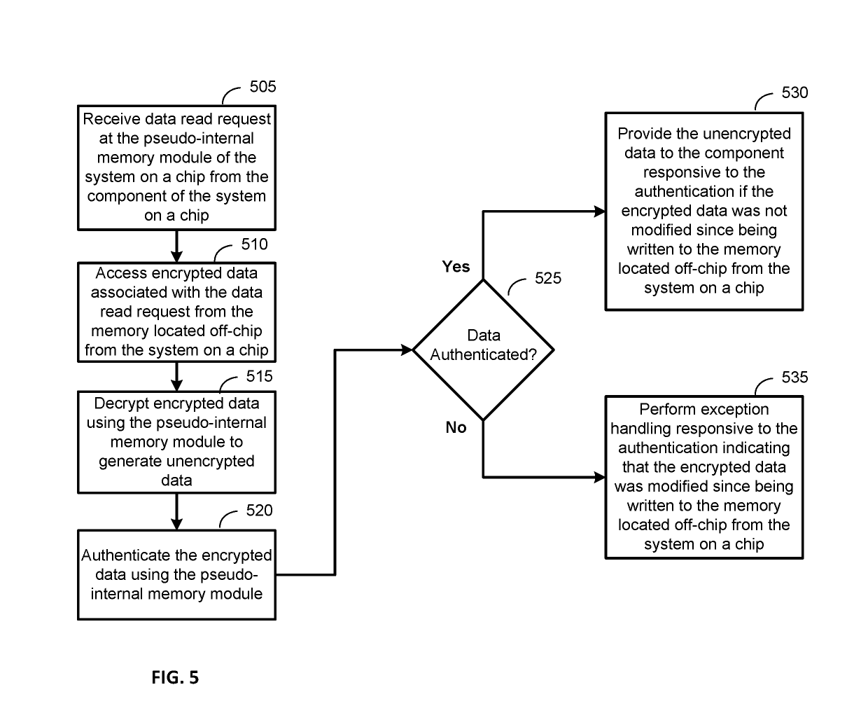

FIG. 5 is a flow diagram of an example process for a read operation on a system on a chip using a pseudo-internal memory module according to the techniques disclosed herein. The process illustrated in FIG. 5 can be implemented in a computing device, such as the computing device 100 illustrated in FIG. 1, and unless otherwise specified, the stages of the process of FIG. 5 can be implemented using the pseudo-internal memory module 115. The process illustrated in FIG. 5 can be used to read and decrypt data stored in the pseudo-internal memory 135 by the pseudo-internal memory module 115 of the computing device 100 according to the process illustrated in FIG. 4.

A data read request can be received at the pseudo-internal memory module 115 of the SoC 105 from a component of the SoC 105 (stage 505). The data read request can comprise a request for a frame of data to be read from the pseudo-internal memory 135 that the pseudo-internal memory module 115 has represented to the other components of the SoC 105 as internal memory. The data read request can include a frame identifier identifying which frame of data to read from the pseudo-internal memory 135. The frame identifier can correspond to the frame address 235 of the frame of data to be read from the pseudo-internal memory 135.

The component of the SoC 105 requesting the frame of data to be read from the pseudo-internal memory 135 need not be configured to perform any additional steps or processing than would ordinarily be required for the component to read from an internal memory of the SoC 105, such as the internal memory 120.

Persons skilled in the art will appreciate that while the example write request illustrated in FIG. 5 discusses reading a frame of data from the pseudo-internal memory 135, the techniques disclosed herein are not limited to a frame of data. Other implementations can be configured to handle other amounts of data. For example, the amount of data that can be requested in a read request may depend at least in part on the types of encryption algorithms and/or modes of encryption algorithms and/or hash algorithms implemented by the pseudo-internal memory module 115 and/or limitations of one or more components of the SoC 105 and/or the off-chip memory 110.

Encrypted data associated with the data read request can be accessed from the pseudo-internal memory 135 located off-chip from the SoC 105 (stage 510). The pseudo-internal memory module 115 can be configured to access the pseudo-internal memory 135 to obtain from the pseudo-internal memory 135 the data requested in the data read request.

The encrypted data can be decrypted using the pseudo-internal memory module 115 to generate unencrypted data (stage 515). For example, the pseudo-internal memory module 115 can be configured to access the reference tag 270 (FIGS. 2 and 3) and any authentication keys specific to the frame or frames of encrypted data requested in the data read request. In one embodiment, the reference tag 270 and authentication keys may be accessed from the tag storage 145 of the off-chip memory 110. Some examples of the keys that can be used to decrypt the encrypted data are illustrated in FIGS. 2 and 3. As discussed above, the decryption block 350 can be configured to decrypt the cipher text frame 280 to generate the plain text frame 345. The plain text frame 345 should match the plain text frame 245 that was provided as an input into the cryptographic write process illustrated in FIG. 2.

The encrypted data can be authenticated using the pseudo-internal memory module 115 (stage 520). The pseudo-internal memory module 115 can be configured to access authentication information associated with the encrypted data that was generated in stage 415 of the process illustrated in FIG. 4. For example, the pseudo-internal memory module 115 can be configured to access the reference tag 270 from the tag storage 145 of the off-chip memory 110 and the secondary authentication key (SAK) 210 associated with the frame from an internal memory of the SoC 105 (e.g., internal memory 120 of FIG. 1). The hash block 365 (FIG. 3) of the pseudo-internal memory module 115 can generate a recovered tag 370 (FIG. 3) based on the cipher text frame 280, the frame address 235, and the SAK 210 associated with the frame. The tag compare block 375 (FIG. 3) of the pseudo-internal memory module 115 can authenticate the encrypted data by comparing the reference tag 270 with the recovered tag 370 to determine whether the two tags are the same.

A determination can be made whether the data was authenticated successfully (stage 525). The tag compare block 375 (FIG. 3) of the pseudo-internal memory module 115 can be configured to output authentication result information 380 that indicates whether the reference tag 270 and the recovered tag 370 matched.

If the data has been authenticated successfully (e.g., the reference tag 270 matches the recovered tag 370), the unencrypted data can be provided to the component requesting the data (stage 530). In other words, the pseudo-internal memory module 115 has determined that the encrypted data was not modified since being written to the pseudo-internal memory 135 located off-chip from the SoC 105. Thus, the data should be safe to release to the component of the SoC 105 requesting the data. For example, the pseudo-internal memory module 115 can be configured to release the plain text frame 345 output by the decryption block 350 as the released frame 390 responsive to the authentication indicating that the encrypted data was not modified. Persons skilled in the art will appreciate that other processing may also be performed on the plain text frame 345 before being released as the released frame 390.

If the data has not been authenticated successfully (e.g., the reference tag 270 does not the recovered tag 370), exception handling can be performed (stage 535). In other words, the pseudo-internal memory module 115 has determined that the encrypted data (e.g., cipher text frame 280) has been modified since the encrypted data was written to the pseudo-internal memory 135 located off-chip from the SoC 105. The data releaser block 385 of the pseudo-internal memory module 115 can be configured to raise a fatal interrupt upon a determination that the cipher text frame 280 was altered since being written to the pseudo-internal memory 135. The alteration may have been due to some sort of an error, but also could have been caused by an attacker attempting to manipulate the operation of the computing device 100. Exception handling processes can be implemented by the SoC 105 to halt the operation of the software associated with the error to prevent damage to the computing device 100.

The example processes illustrated in FIGS. 2-5 can be modified where the pseudo-internal memory module 115 is configured to control a level of protection offered for each frame of data stored in the pseudo-internal memory 135. As discussed above, implementations of the pseudo-internal memory module 115 can be configured to provide a confidentiality-only protection level, an integrity only protection level, a confidentiality and integrity protection level, and confidentiality, integrity, and/or replay protection level.

Where the pseudo-internal memory module 115 is configured to provide confidentiality protection, the data stored in the pseudo-internal memory 135 can be encrypted or otherwise obfuscated by the pseudo-internal memory module 115 before being written to the pseudo-internal memory 135. The example processes illustrated in FIGS. 2-4 provide for confidentiality protection. Where the pseudo-internal memory module 115 is configured to provide confidentiality protection only, the data stored in the pseudo-internal memory 135 can be encrypted or otherwise obfuscated by the pseudo-internal memory module 115 before being written to the pseudo-internal memory 135, but the authentication related stages of the processes illustrated in FIGS. 4 and 5 can be omitted. The process illustrated in FIG. 4 can be altered to omit stage 420 and to modify stage 425 such that the encrypted data is written to the pseudo-internal memory 135 but no reference tag 270 or other authentication information is written to the tag storage 145. The process illustrated in FIG. 5 can be altered to omit stages 520 and 525 and to execute stage 530 following stage 515.

Where the pseudo-internal memory module 115 is configured to provide replay protection, the pseudo-internal memory module 115 can be configured to provide a SoC-stored component of the key or other information used to encrypt or obfuscate the data in the pseudo-internal memory 135 that can protect against replay attacks. Where such replay protection is required, at least a portion of the encryption key or keys used to encrypt the data in stage 415 and/or to generate the authentication information in stage 420 of the process illustrated in FIG. 4 must include at least one component that is stored in a substantially inaccessible memory area of the SoC 105 and/or that is built into the SoC 105. For example, the at least one component may be burned into a one-time programmable memory of the SoC 105 that is substantially inaccessible from outside the SoC 105. The process illustrated in FIG. 5 would require that at least one component of the decryption key or keys used in stage 515 and the authentication key or keys used in stage 520 be stored in a substantially inaccessible memory area of the SoC 105 and/or that is built into the SoC 105. The example processes illustrated in FIGS. 2 and 3 utilize such components and provide for replay protection.

Where the pseudo-internal memory module 115 is configured to provide integrity protection, the pseudo-internal memory module 115 can generate a message authentication code or other authentication information for determining whether the contents of the pseudo-internal memory 135 have been altered. The processes illustrated in FIGS. 2-4 provide for such protection. Where the pseudo-internal memory module 115 is configured to provide integrity protection but not for confidentiality protection, the processes illustrated in FIGS. 2-4 can be modified to omit or modify stages related to encrypting and decrypting the data. For example, stage 415, stage 420 and stage 425 of the process illustrated in FIG. 4 could be modified. For instance, stage 415 can be modified to generate the authentication data based on the plain text frame 245, and stage 425 can be modified to store the authentication information in the tag storage 145 and the unencrypted data in the pseudo-internal memory 135. Other levels of protection in addition to and/or instead of one or more of the levels of protection can be provided, and the processes illustrated in FIGS. 4 and 5 can be modified accordingly.

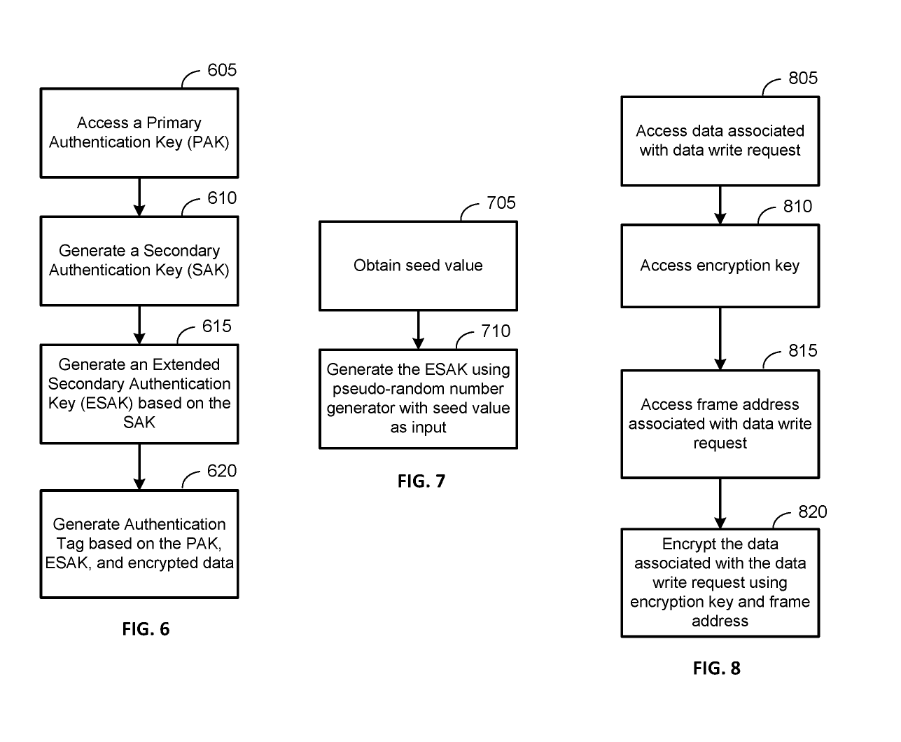

FIG. 6 is a flow diagram of an example process for generating an authentication tag according to the techniques disclosed herein. The process illustrated in FIG. 6 can be implemented in a computing device, such as the computing device 100 illustrated in FIG. 1, and unless otherwise specified, the stages of the process of FIG. 6 can be implemented using the pseudo-internal memory module 115. The process illustrated in FIG. 6 can be used to implement at least a portion of stage 420 of the process illustrated in FIG. 4.

A primary authentication key (PAK) can be accessed (stage 605). For example, the pseudo-internal memory module 115 can be configured to access the PAK 275 (FIG. 2) from an on-chip memory that is part of the SoC or is built into the SoC 105 such that the PAK 275 is substantially inaccessible from outside of the SoC 105. The PAK 275 may be valid only for the power cycle, and the SoC 105 can be configured to regenerate the PAK 275 each time that the SoC 105 is rebooted. The PAK 275 may not be a frame-specific authentication key and thus may be used to generate the reference tag 270 for each of the frames of data to be stored in the pseudo-internal memory 135.

A secondary authentication key (SAK) can be generated (stage 610) by the pseudo-internal memory module 115. For example, the SAK 210 (FIG. 2) is an authentication key that is associated with a particular frame of data to be encrypted and stored in the pseudo-internal memory 135. The SAK 210 can be generated by the pseudo-internal memory module 115. The SAK 210 can be stored in the SAK memory 205 located on the SoC 105 and can be associated with the frame address 235 of the frame of data to be encrypted and written to the pseudo-internal memory 135.

An extended secondary authentication key (ESAK) can be generated based on the SAK by the pseudo-internal memory module 115 (stage 615). For example, the ESAK 240 (FIG. 2) can be generated by concatenating the SAK 210 with the frame address 235. Persons skilled in the art will appreciate that the ESAK can be generated by the pseudo-internal memory module 115 using other techniques.

An authentication tag can be generated based on the PAK, ESAK, and the encrypted data by the pseudo-internal memory module 115 (stage 620). For example, the authentication tag generated at stage 620 can be the reference tag 270 (FIG. 2). The ESAK 240 can be concatenated with the cipher text frame 280 (also referred to herein as the encrypted data) by the pseudo-internal memory module 115. The pseudo-internal memory module 115 can be configured to provide the concatenated value comprising the cipher text frame 280 and ESAK 240 as one parameter to a message authentication code algorithm and the PAK 275 as a second parameter to the message authentication code algorithm.

The pseudo-internal memory module 115 can be configured to implement various types of message authentication code algorithms, including but not limited to, a SipHash algorithm to generate a reference tag 270. The reference tag 270 serves as a reference value that can be stored in the tag storage 145 or in an on-chip memory of the SoC 105. The reference tag 270 can be used to later determine whether the cipher text frame 280 was modified since it was generated and stored in the pseudo-internal memory module 115. An attacker or malicious process attempting to modify the cipher text data 280? would also need to be able to locate the reference tag 270 in the tag storage 145 and/or in the on-chip memory of the SoC 105. Furthermore, the attacker would need to regenerate the reference tag 270 using the same techniques that were originally used to generate the reference tag 270. However, such an attack would be very unlikely to succeed since the reference tag 270 was generated using an encryption key (EK 255), a primary authentication key (PAK 275), a secondary authentication key (SAK 210), and an extended secondary authentication key (ESAK 240) that are substantially inaccessible from outside of the SoC 105.

Returning to stage 610 of the process of FIG. 6, the pseudo-internal memory module 115 can include a PRNG block 220 (FIG. 2) that can be used to generate the SAK 210 using a process such as that illustrated in FIG. 7.

FIG. 7 is a flow diagram of an example process for generating a secondary authentication key according to the techniques disclosed herein. The process illustrated in FIG. 7 can be implemented in a computing device, such as the computing device 100 illustrated in FIG. 1, and unless otherwise specified, the stages of the process of FIG. 7 can be implemented using the pseudo-internal memory module 115. The process illustrated in FIG. 7 can be used to implement at least a portion of the stage 610 of the process illustrated in FIG. 6.

A seed value can be obtained (stage 705). For example, the pseudo-internal memory module 115 can be configured to generate a seed value that can be used by the PRNG block 220. The pseudo-internal memory module 115 or another component of the SoC 105 can be configured to generate the seed value at power up of the computing device 100. The seed value 215 can also be a selected value that is stored in an on-chip memory of the SoC 105 and/or can be built into the pseudo-internal memory module 115 or the SoC 105. The pseudo-internal memory module 115 can be configured to access the seed value from the appropriate location in order to provide the seed value to the PRNG block 220.

The ESAK can be generated using a pseudo-random number generated with the seed value as input (stage 710). For example, the PRNG block 220 can be configured such that the PRNG block 220 will produce the same sequence of numbers whose properties approximate the properties of a sequence of random numbers given the same seed value. The seed value can be selected from a set of seed values such that the period of the PRNG is not shorter than a selected threshold. The ESAK can be one or more numbers generated by the PRNG block 220. The pseudo-internal memory module 115 can also be configured to perform one or more computations or operations on the value output by the PRNG block 220 to generate the ESAK.

Alternatively, persons skilled in the art will appreciate that the pseudo-internal memory module 115 can be configured to generate the SAK 210 using any other suitable techniques. For example, the pseudo-internal memory module 115 can implement a Hash-based Message Authentication Code (HMAC)-based Key Derivation Function (HKDF) to generate the secondary authentication key (SAK 210).

FIG. 8 is a flow diagram of an example process for encrypting data according to the techniques disclosed herein. The process illustrated in FIG. 8 can be implemented in a computing device, such as the computing device 100 illustrated in FIG. 1, and unless otherwise specified, the stages of the process of FIG. 8 can be implemented using the pseudo-internal memory module 115. The process illustrated in FIG. 8 can be used to implement at least a portion of stage 415 of the process illustrated in FIG. 4.

Data associated with a data write request can be accessed (stage 805). For example, the pseudo-internal memory module 115 can be configured to access the plain text frame 245 (FIG. 2) received with a data write request from a component of the SoC 105. The data is received in an unencrypted form from one of the master device of the master devices 170 of the SoC 105. The data is to be written to a frame address 235 that maps to a portion of the pseudo-internal memory 135, which appears to the components of the SoC 105 to be part of the internal memory 120 of the SoC 105.

Persons skilled in the art will appreciate that while the example write request illustrated in FIG. 8 discusses writing a frame of data to the pseudo-internal memory 135, the techniques disclosed herein are not limited to a frame of data. Other implementations can be configured to handle other amounts of data. The amount of data that can be included in a data write request may depend at least in part on the types of encryption algorithms and/or modes of encryption algorithms and/or hash algorithms implemented by the pseudo-internal memory module 115 and/or limitations of one or more components of the SoC 105 and/or the off-chip memory 110.

An encryption key can be accessed (stage 810). For example, the pseudo-internal memory module 115 can be configured to access an encryption key (EK 255 of FIG. 2). The EK 255 is not frame specific and can be used by the pseudo-internal memory module 115 to generate the cipher text frame 280 for each frame of data to be stored in the pseudo-internal memory 135. The EK 255 can be stored in an on-chip memory (e.g., internal memory 120 of FIG. 1) or built into the SoC 105 such that the EK 255 is substantially inaccessible outside of the SoC 105. In one embodiment, the EK 255 may be valid only for the power cycle, and the SoC 105 and/or the pseudo-internal memory module 115 can be configured to regenerate the EK 255 each time that the SoC 105 is rebooted.

A frame address associated with the data write request can be accessed (stage 815). For example, the pseudo-internal memory module 115 can be configured to obtain the frame address 235 of the frame of encrypted data 280 associated with the data write request. The component of the SoC 105 that is transmitting the data write request can reference the frame address 235 of the data directly. This is because the contents of the pseudo-internal memory 135 are mapped such that the contents appear to be stored in an internal memory of the SoC to the components of the SoC. In one embodiment, the frame address 235 represents the address of the frame in the slave address space provided by the pseudo-internal memory module 115. For example, the slave address space can map to at least a portion of the internal memory 120 and/or the pseudo-internal memory 135. In addition or alternatively, the slave address space can map to other internal memory of the SoC 105.

The data associated with the data write request can be encrypted using the encryption key and the frame address (stage 820). For example, the pseudo-internal memory module 115 can be configured to encrypt the data associated with the data write request using the AES-128 XTS encryption algorithm as discussed above with respect to FIG. 2. As another example, the pseudo-internal memory module 115 can be configured to use other encryption techniques in addition to or instead of the AES-128 XTS encryption algorithm. The pseudo-internal memory module 115 can be configured to receive the data to be encrypted as a plain text frame 245 of data and to output cipher text frame 280. The pseudo-internal memory module 115 can be configured to use the EK 255 and the frame address 235 associated with the data write request as parameters of the encryption algorithm.

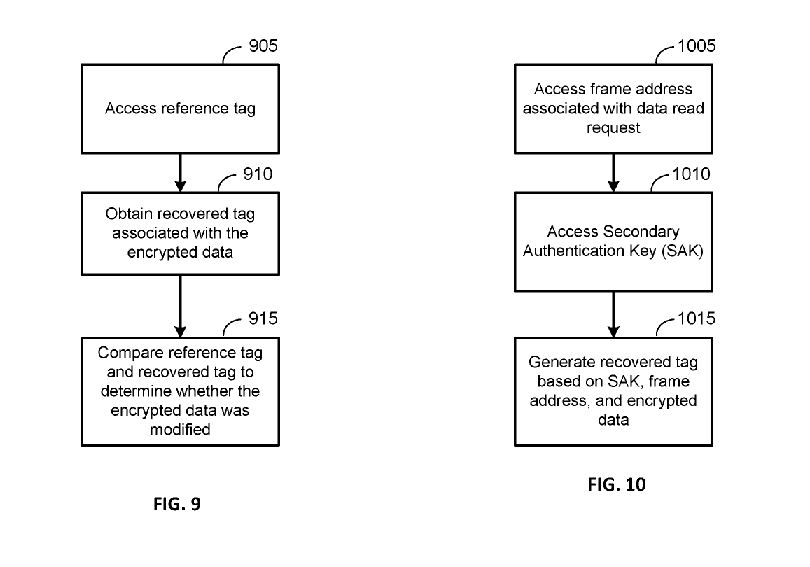

FIG. 9 is a flow diagram of an example process for authenticating encrypted data according to the techniques disclosed herein. The process illustrated in FIG. 9 can be implemented in a computing device, such as the computing device 100 illustrated in FIG. 1, and unless otherwise specified, the stages of the process of FIG. 9 can be implemented using the pseudo-internal memory module 115. The process illustrated in FIG. 9 can be used to implement at least a portion of stage 520 of the process illustrated in FIG. 5. The process illustrated in FIG. 9 can be used to authenticate encrypted data (e.g., cipher text frame 280 stored in the pseudo-internal memory 135) to determine whether the encrypted data was modified since the data was written to the pseudo-internal memory 135.

A reference tag can be accessed (stage 905). For example, a reference tag 270 can be accessed from the tag storage 145 or an internal storage of the SoC 105. The reference tag 270 can be stored in a data structure such that the reference tag 270 can be looked up by the frame address 235 associated with the cipher text frame 280 to be authenticated. The pseudo-internal memory module 115 can be configured to use one of the many types of data structure known to the art for organizing data such that the data can be looked up later to organize the reference tags stored in the tag storage 145. The pseudo-internal memory module 115 can be configured to access the reference tag 270 from the appropriate memory location.

A recovered tag associated with the encrypted data can be obtained (stage 910). The pseudo-internal memory module 115 can be configured to generate a recovered tag 370 based on the encrypted data 280, the frame address 235, and the SAK 210. An example process for generating the recovered tag 370 is illustrated in FIG. 10, which is discussed in detail below. The recovered tag 370 is generated based on the encrypted data retrieved from the pseudo-internal memory 135 and can be used to determine whether the cipher text frame 280 has been altered since the encrypted data was generated and stored.

The reference tag and the recovered tag can be compared to determine whether the encrypted data was modified (stage 915). The pseudo-internal memory module 115 can be configured to compare the recovered tag 370 with the reference tag 270. If the two tags are determined not to match, then the encrypted data 280 may have been modified or corrupted while stored in the pseudo-internal memory 135. It is also possible that the reference tag 270 may have been tampered with or corrupted. The pseudo-internal memory module 115 can be configured to perform one or more exception handling actions responsive to the recovered tag 370 not matching the reference tag 270. The pseudo-internal memory module 115 can be configured to release the decrypted data to a component of the SoC 105 requesting the data in a read request responsive to the recovered tag 370 matching the reference tag 270.

FIG. 10 is a flow diagram of an example process for a generating a recovered tag from encrypted data according to the techniques disclosed herein. The process illustrated in FIG. 10 can be implemented in a computing device, such as the computing device 100 illustrated in FIG. 1, and unless otherwise specified, the stages of the process of FIG. 10 can be implemented using the pseudo-internal memory module 115. The process illustrated in FIG. 10 can be used to implement at least a portion of stage 910 of the process illustrated in FIG. 9.

A frame address associated with the data read request can be accessed (stage 1005). The pseudo-internal memory module 115 can be configured to obtain the frame address 235 of the frame of encrypted data (e.g., cipher text frame 280) to be accessed from a data read request received from a component of the SoC 105. The frame address 235 can represent the address of the frame in the slave address space provided by the pseudo-internal memory module 115. The component of the SoC 105 can reference the frame address 235 of the data directly since the contents of the pseudo-internal memory 135 are mapped such that the contents appear to be stored in an internal memory of the SoC to these components.

A secondary authentication key (SAK) can be accessed (stage 1010). The pseudo-internal memory module 115 can be configured to use the frame address 235 of the frame of encrypted data 280 to look up the SAK 210 associated with the encrypted data 280 from the SAK memory 205.

A recovered tag 370 can be generated based on the SAK, the frame address, and the encrypted data (stage 1015). The pseudo-internal memory module 115 can be configured to generate the recovered tag 370 using the same algorithm used to generate the reference tag 270 when the data was encrypted. For example, the pseudo-internal memory module 115 can be configured to implement various types of message authentication code algorithms, including but not limited to, a SipHash algorithm to generate a reference tag 270. Accordingly, the pseudo-internal memory module 115 can be configured to use the same technique when generating the recovered tag 370.

In one embodiment, the pseudo-internal memory module 115 can be configured to implement more than one type of message authentication code algorithm and can be configured to select a particular algorithm to use for generating the reference tag 270 and the recovered tag 370 at power up of the computing device 100. For example, the pseudo-internal memory module 115 can be configured to select a particular algorithm to use for generating the reference tag 270 and the recovered tag 370 based on the seed value 215 or another value determined upon powering up the computing device 100.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for protecting sensitive data, the method comprising:
presenting, by a pseudo-internal memory module of a system on a chip, an address space as internal memory of the system on a chip, wherein the address space comprises memory located off-chip from the system on a chip;
receiving a data write request at the pseudo-internal memory module from a component of the system on a chip;
encrypting data associated with the data write request using the pseudo-internal memory module to generate encrypted data; and
writing the encrypted data to the memory located off-chip from the system on a chip.

2. The method of claim 1, further comprising:
generating authentication information for authenticating the encrypted data, and
writing at least a portion of the authentication information for authenticating the encrypted data to the memory located off-chip from the system on a chip.

3. The method of claim 2, wherein generating the authentication information for authenticating the encrypted data comprises generating an authentication tag associated with the data, and wherein writing the at least the portion of the authentication information for authenticating the encrypted data to the memory located off-chip from the system on a chip comprises writing the authentication tag to the memory located off-chip from the system on a chip.

4. The method of claim 3, further comprising:
receiving a data read request at the pseudo-internal memory module from the component of the system on a chip;
accessing the encrypted data associated with the data read request from the memory located off-chip from the system on a chip;
decrypting the encrypted data using the pseudo-internal memory module to generate unencrypted data; and
authenticating the encrypted data using the pseudo-internal memory module;
providing the unencrypted data to the component responsive to the authentication if the encrypted data was not modified since being written to the memory located off-chip from the system on a chip.

5. The method of claim 4, wherein accessing the encrypted data associated with the data read request from the memory located off-chip from the system on a chip further comprises accessing the authentication tag associated with the data; and wherein authenticating the encrypted data using the pseudo-internal memory module comprises authenticating the encrypted data using the authentication tag.

6. The method of claim 4, further comprising:
performing exception handling responsive to the authentication indicating that the encrypted data was modified since being written to the memory located off-chip from the system on a chip.

7. An apparatus comprising:
means for presenting, by a pseudo-internal memory module of a system on a chip, an address space as internal memory of the system on a chip, wherein the address space comprises memory located off-chip from the system on a chip;
means for receiving a data write request at the pseudo-internal memory module from a component of the system on a chip;
means for encrypting data associated with the data write request using the pseudo-internal memory module to generate encrypted data; and
means for writing the encrypted data and authentication information to the memory located off-chip from the system on a chip.

8. The apparatus of claim 7, further comprising:
means for generating authentication information for authenticating the encrypted data, and
means for writing at least a portion of the authentication information for authenticating the encrypted data to the memory located off-chip from the system on a chip.

9. The apparatus of claim 8, wherein the means for generating the authentication information for authenticating the encrypted data comprises means for generating an authentication tag associated with the data; and wherein the means for writing the at least the portion of the authentication information for authenticating the encrypted data to the memory located off-chip from the system on a chip comprises means for writing the authentication tag to the memory located off-chip from the system on a chip.

10. The apparatus of claim 9, further comprising:
means for receiving a data read request at the pseudo-internal memory module from the component of the system on a chip;
means for accessing the encrypted data associated with the data read request from the memory located off-chip from the system on a chip;
means for decrypting the encrypted data using the pseudo-internal memory module to generate unencrypted data;
means for authenticating the encrypted data using the pseudo-internal memory module; and
means for providing the unencrypted data to the component responsive to the authentication if the encrypted data was not modified since being written to the memory located off-chip from the system on a chip.

11. The apparatus of claim 10, wherein the means for accessing the encrypted data associated with the data read request from the memory located off-chip from the system on a chip further comprises means for accessing the authentication tag associated with the data; and wherein the means for authenticating the encrypted data using the pseudo-internal memory module comprises means for authenticating the encrypted data using the authentication tag.

12. The apparatus of claim 10, further comprising:
means for performing exception handling responsive to the authentication indicating that the encrypted data was modified since being written to the memory located off-chip from the system on a chip.

13. A system on a chip comprising:
a pseudo-internal memory module;
one or more components configured to read, write, or read and write data from memory associated with the pseudo-internal memory module; and
a system interconnect configured to connect the one or more components and the pseudo-internal memory module;
the pseudo-internal memory module being configured to
present an address space as internal memory of the system on a chip, wherein the address space comprises memory located off-chip from the system on a chip,
receive a data write request from a component of the one or more components to write data to the memory associated with the pseudo-internal memory module,
encrypt the data associated with the data write request to generate encrypted data, and
write the encrypted data to the memory located off-chip from the system on a chip.

14. The system on a chip of claim 13, wherein the pseudo-internal memory module is further configured to:
generate authentication information for authenticating the encrypted data, and
write at least a portion of the authentication information for authenticating the encrypted data to the memory located off-chip from the system on a chip.

15. The system on a chip of claim 14, wherein the pseudo-internal memory module is configured to generate an authentication tag associated with the data; and wherein the pseudo-internal memory module is configured to write the authentication tag to the memory located off-chip from the system on a chip.

16. The system on a chip of claim 15, where the pseudo-internal memory module is configured to:
receive a data read request from the component of the one or more components;
access the encrypted data associated with the data read request from the memory located off-chip from the system on a chip;
decrypt the encrypted data to generate unencrypted data;
authenticate the encrypted data; and
provide the unencrypted data to the component responsive to the authentication if the encrypted data was not modified since being written to the memory located off-chip from the system on a chip.

17. The system on a chip of claim 16, wherein the pseudo-internal memory module is configured to access the authentication tag associated with the data; and wherein the pseudo-internal memory module is configured to authenticating the encrypted data using the authentication tag.

18. The system on a chip of claim 16, where the pseudo-internal memory module is configured to:
perform exception handling responsive to the authentication indicating that the encrypted data was not modified since being written to the memory located off-chip from the system on a chip.

19. A computing device comprising:
a system on a chip; and
a memory located off-chip from the system on a chip;
the system on a chip being in communication with the memory located off-chip from the system on a chip, the system on a chip further comprising a pseudo-internal memory module, the pseudo-internal memory module being configured to
present an address space as internal memory of the system on a chip, the address space comprising memory of the memory located off-chip from the system on a chip,
receive a data write request from a component of the system on a chip,
encrypt data associated with the data write request to generate encrypted data, and
write the encrypted data to the memory located off-chip from the system on a chip.

20. The computing device of claim 19, wherein the pseudo-internal memory module is further configured to:
generate authentication information for authenticating the encrypted data, and
write at least a portion of the authentication information for authenticating the encrypted data to the memory located off-chip from the system on a chip.

21. The computing device of claim 20, wherein the pseudo-internal memory module is configured to generate an authentication tag associated with the data; and wherein the pseudo-internal memory module is configured to write the authentication tag to the memory located off-chip from the system on a chip.

22. The computing device of claim 21, where the pseudo-internal memory module is configured to:
receive a data read request from the component of the system on a chip;
access the encrypted data associated with the data read request from the memory located off-chip from the system on a chip;
decrypt the encrypted data to generate unencrypted data;
authenticate the encrypted data; and
provide the unencrypted data to the component responsive to the authentication indicating that the encrypted data was not modified since being written to the memory located off-chip from the system on a chip.

23. The computing device of claim 22, wherein the pseudo-internal memory module is configured to access the authentication tag associated with the data; and wherein the pseudo-internal memory module is configured to authenticating the encrypted data using the authentication tag.

24. The computing device of claim 22, where the pseudo-internal memory module is configured to:
perform exception handling responsive to the authentication if the encrypted data was not modified since being written to the memory located off-chip from the system on a chip.
